(19) United States
(12) Patent Application Publication
(10) Pub. No.: US 2026/0300494 A1
(43) Pub. Date: Oct. 1, 2026

(54) RISK DETECTION OF CROSS-CHANNEL ACTIVITIES FOR OMNICHANNEL COMPUTING SERVICES

(71) Applicant: PAYPAL, INC., San Jose, CA (US)

(72) Inventors: Padmapriya Mohankumar, Chennai (IN); Ashraf Kamal, New Delhi (IN); Vishal Kumar Singh, Howrah (IN)

(21) Appl. No.: 19/091,191

(22) Filed: Mar. 26, 2025

(51) Int. Cl. G06F 21/57

(52) U.S. Cl. CPC G06F 21/577; G06F 2221/034

(57) ABSTRACT

Computer security improvements relating to risk detection of cross-channel activities for omnichannel computing services are disclosed. A service provider may utilize a framework for detecting and protecting from fraud and other behaviors indicative of risk, account takeovers, or other malicious activity with omnichannel computing services. In this regard, the service provider may provide omnichannel services, which may be offered for use in multiple different service and communication channels. To perform risk detection and mitigation across multiple channels for these omnichannel services, the service provider may train one or more machine learning or other AI models based on cross-channel activities and events associated with users. Users and their activities and events may be linked by graph-based channel networks, which may be encoded to different features for model training. Features from patterns in cross-channel activities may be used with the AI models to real-time monitoring and alerting.

### TECHNICAL FIELD

The present application generally relates to risk detection for omnichannel computing services, and more particularly to identifying and evaluating risk for digital activities performed through different channels for omnichannel computing services.

### BACKGROUND

Users may utilize computing devices to access online domains and platforms to perform various computing operations and view available data. Generally, these operations are provided by different service providers, which may provide services for account establishment and access, messaging and communications, electronic transaction processing, and other types of available services. However, as hackers and other malicious users or entities become more sophisticated, they may perform more complex computing attacks and other malicious conduct to compromise these communications. Fraud, account takeovers (ATOs), money laundering schemes, and the like are constantly changing, and new strategies, vulnerabilities, or other techniques by which fraud can be conducted are increasingly being used by bad actors.

Without accurately and quickly identifying these attackers and performing remedial actions, the service provider may risk fraud, loss, and decreased customer trust or satisfaction. As such, intelligent systems for automating fraud detection and prevention require more advanced and evolving techniques and solutions trained from complex behavior patterns. Service providers may prefer to implement omnichannel services for their wide applicability and customer outreach potential. However, omnichannel services face challenges related to data privacy and security not typically encountered by conventional service channels, and introduce risks related to cybersecurity, payment fraud, lending fraud, sensitive data breach, privacy, regulatory compliance, etc. As such, there is a need to improve the operational efficiency and data security of interactions and services provided via omnichannel services while enabling cross-channel data processing in a fast and efficient manner.

### BRIEF DESCRIPTION OF THE DRAWINGS

FIG. 1 is a block diagram of a networked system suitable for implementing the processes described herein, according to an embodiment;

FIG. 2 is an exemplary system environment where a machine learning or other artificial intelligence system may be implemented to detect and mitigate from fraud and other risk with omnichannel services, according to an embodiment;

FIGS. 3A-3F are exemplary diagrams of a risk and fraud detection and mitigation system for omnichannel services, according to an embodiment;

FIG. 4 is a flowchart for risk detection of cross-channel activities for omnichannel computing services, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for risk detection of cross-channel activities for omnichannel computing services. Systems suitable for practicing methods of the present disclosure are also provided. Note that while various examples, structures, techniques, etc. may be described with respect to a service provider in this specification, these structures, techniques, etc. are generalizable and are applicable to any entity that implements security systems and defenses described herein for omnichannel services and other interactions with users through multiple different channels, according to various embodiments.

Service providers may provide omnichannel services, which refer to the integration of various communication and interaction channels for a unified user experience (UX). Omnichannel services enable user to interact with their service provider through multiple platforms and channels, including mobile applications, websites, automated devices and machines, phone calls, physical locations, and call centers. These interactions are connected via the different channels to provide a consistent, personalized, and unified experience. This may assist with aligning the UX across various platforms, enabling service providers to meet demands for accessibility, personalization, and convenience. In a service provider's system, the service provider may provide a computing architecture that may face different types of fraud and computing attacks coming from malicious sources over a network. For example, malicious and fraudulent users may attempt to compromise the service provider's online platform, software applications, websites, retail and/or point-of-sale (POS) devices, payment and/or teller terminals and machines, and other computing systems that allow users to interact with, use, and request data processing.

By providing omnichannel services, users may interact with service providers via mobile applications, online portals, social media, chatbots, phone support, physical branches, etc., providing flexibility and convenience to users. Further, with the help of advanced data analytics and AI, omnichannel services provide tailored service and product recommendations based on user profiles and behaviors, preferences, and past interactions. Service providers may gather data across multiple channels to enhance customer insights, thereby improving service delivery and identifying new opportunities for engagement with users. Users may then choose the most convenient channel for their interactions, which allows for consistency and personalization across different channels. This also allows for streamlining of operations, reducing redundancy and ensuring a smoother flow of information between channels and systems.

However, use of omnichannel services and interactions may lead to loss due to fraud. Fraud may include unlawful and/or unauthorized transactions, which may cause loss for customers including individual users and merchants or other business entities, as well as loss for the service provider (e.g., an online transaction processor). Computing attacks against the service provider may include ATOs, where a malicious entity (e.g. fraudster) may gain access to an account and/or otherwise compromise the account to engage in fraudulent, malicious, and/or illegitimate actions or operations with the account. As such, fraud and other malicious computing attacks and activities may compromise accounts, computing services, products, data, and/or financial instruments and funds in the computing environment of the service provider. Fraudsters may also compromise accounts and computing systems through unauthorized acquisition of sensitive personal, financial, and/or authentication information from users, such as through malware, phishing attacks, and the like.

Conventionally within a risk system, models and strategies may be capable of identifying some fraudsters based on simple fraud patterns, behaviors, and trends in activities. However, these conventional systems are not capable of understanding and identifying more complex fraud patterns and trends that may occur with omnichannel computing services. For example, a malicious actor may initiate a computing attack on the computing environment of the service provider that may compromise services (e.g., electronic transaction processing services) and/or expose data (e.g., personally identifiable information (PII) and/or funding source information) to the malicious actor in one channel for an omnichannel service, but may also initiate or perform a scripted bot attack in another channel of that omnichannel service to gain access to other data that may be used with ATO or fraud. Computing attacks may be executed through live users, as well as automated computing bots or operations, such as executable scripts and bots that may quickly repeat computing attacks. Shell scripts may automate other processes and operations, including program or application executables that automate execution of scripts for computing attacks and fraud, which allows for multiple different sources of computing attacks that compromise omnichannel services having multiple different entry points and vectors for computing attacks.

To reduce risk, fraud, and loss with omnichannel computing services, online transaction processors and other online service providers may implement a security and threat detection system as discussed herein to detect and mitigate these computing attacks and other abuses attempted by fraudsters in multiple different service channels. The risk detection and fraud prevention framework and system may predict, classify, and/or detect if a computing device and/or communications may be used by a malicious actor and/or computing bot or script from omnichannel activities and interactions. As such, the framework may provide an automated fraud detection system that may detect and categorize suspicious and/or risky interactions and activities over omnichannel services. This pipeline uses artificial intelligence (AI) systems, such as deep learning models (e.g., neural networks (NNs) and/or deep NNs (DNNs)) that incorporate customer profiling and behavioral features for activities with omnichannel services. The outcome is a precise tagging and grouping of fraudulent interactions and users that may be engaged in use of omnichannel services of a service provider.

With omnichannel computing services, the use of multiple different communication and interaction channels may provide service providers with additional presence, compatibility, and accessibility for computing services that may be offered to users. These activities may be monitored and classified through correlations between activities in each channel and corresponding accounts. In particular, omnichannel services may allow customers to start a process on one channel (e.g., a mobile application) and continue the process and/or interaction on another (e.g., a website or in-person at a location or branch of the service provider) without needing to repeat information previously provided. As such, this also allows for unified user data and use of integrated systems to ensure user data is consistent and up-to-date across all platforms and computing services. This enhances personalized services as service providers may track user activities and behaviors across all channels. This further provides for the ability to track users, devices, accounts, and/or identifiers across multiple different channels, thereby enabling the service provider to implement a risk detection system that may unify the activities of users, devices, or the presence of other actors across these channels.

The intelligent risk and fraud detection system may detect different risks in omnichannel services and allow for analysis of risks between interactions that are cross-channel, channel-specific (i.e., between the channel and customer), service provider-to-channel, and channel-to-application programming interface (API)-to-customer integrations, as well as customer profiling risks. The fraud detection system may be scalable and connected via multiple sources and executable on edge devices, such that the system is made computationally efficient and human intervention is not required for continuous evaluation in real-time. The risk and fraud detection system may implement customer, device, and/or account profiling, which may utilize one or more APIs to determine information for the user or other entity interacting with one or more channels (e.g., a device, account, identifier, business, etc.). The profiling may be based on transaction records and a transaction network, user activities and participants to those activities, and/or behavioral logs associated with the user, device, account, identifier, or the like.

Customer profiling may include psychometric profiling, suspicious complaint patterns, multi-layered identity verification, etc. From this data, graph-based cross-channel networks may be formed. These graphs may correspond to relationship graphs or other visual and/or processable representations of each user to events of the user, where the events may be identified as normal channel events or vulnerable channel events, and have a normal link or a vulnerable link associated with the respective events. The nodes and edges may be encoded from the customer profiling data, and pattern learning may then be performed to identify and learn patterns in the cross-channel graphs for different users. Pattern learning may include merging or identifying correlations and interactions between users, devices, accounts, identifiers, or the like based on their shared events, such that variant patterns that change across channels and invariant patterns that remain consistent among channels can be identified.

As such, the system may utilize multiple risk capturing modules, which may be used to identify patterns that can be used by AI models, such as ML models trained for pattern analysis and risk detection, to determine risk, fraud, and the like. These models and other modules for risk analysis may include cross-channel risk detection for risks that arise when the different communication and interaction channels fail to work together correctly or in a smooth and efficient manner. For example, risks may occur with and impact financial operations, data integrity, customer satisfaction, and overall business performance. To capture risks in cross-channel usage and interaction, the fraud detection system may detect channel silos, cross-channel phishing attacks, channel hopping interactions, and the like, and assess those interactions and users for risk. With channel-specific risk detection, there may be distinct challenges, vulnerabilities, and potential risks that arise between users and channels. This may include channel-specific risks, like channel cannibalization, channel overlap, promotional abuse, integration risk, etc.

A risk model and/or system may be trained and utilized by the system for those specific risk scenarios. With bank-channel risk detection, banks (or other financial institutions) may require identifying and managing potential risks that could affect financial transactions and interactions through various communication channels and entities. These risks, and corresponding risk models trained for identification and assessment of such risks, may include social engineering attacks, regulatory risks, and data breach risks, etc. With API-integration risk detection, risk models may be trained for identifying and mitigating potential risks associated with integrating third-party APIs into omnichannel services. These risks may include API abuse, session hijacking, skimming, bot attacks, etc. As such, risk models may be used for analyzing a customer's behavior across multiple channels (e.g., online, mobile applications, etc.) to identify unusual or potentially fraudulent activities.

After profiling customers for risk detection within an omnichannel environment, as well as forming graph-based channel networks and performing dynamic pattern learning, risk models may be trained and created for omnichannel risk activities and threat detection/mitigation. To train models, features may be required to be selected and/or engineered for model inferences, where features may correspond to relevant information extracted from raw data for a dataset. Features may correspond to data attributes or variables that may vary over different customers and/or datasets, and may correspond to the individual measurable property, characteristic, or the like that is to be analyzed for ML inferencing. Mutable-structure features may be extracted from variant and invariant patterns and may further undergo feature hybridization to generate a set of mutable-network-structural features. To provide sequence information with the features, a sequence-information-based transformation layer may be used, and an encoder may encode the output features for ML model training and inferencing. Pattern-based contextual encoding may be applied to the dynamic channel pattern learning with the variant and invariant patterns to generate a contextual encoding of the data, and therefore an embedding of that data that may be used with the features from the transformation layer for ML model training and inferencing. The output features from the two processes may be used to train one or more ML models for omnichannel risk detection of cross-channel activities and user engagements, as well as perform inferencing of omnichannel risk for one or more activities from the feature data resulting from these operations.

Since omnichannel environments provide seamless UXs across different touchpoints, the omnichannel services may also create more opportunities for fraudsters to exploit vulnerabilities. As such, the trained ML models or other AI components may then be used for a risk and feature detection system with omnichannel activities, users, and other interactions. The detection system may utilize real-time risk and fraud monitoring using the trained ML models, which may trigger real-time alerts for suspicious activities, such as unusual login attempts, sudden changes to account information, or abnormal transaction behavior. The detection system may then continuously monitor transactions in real time across all channels to detect suspicious activities, which may include unusual transaction amounts, high-frequency transfers, or transactions from unfamiliar locations. When suspicious activity is detected, the system may track the location and device being used in real-time to detect unusual access patterns. Geolocation and device fingerprinting may allow the service provider to verify if the user is logging in from an authorized location and device. The system may assign risk scores to customer activities based on various factors such as transaction type, location, device, and past behavior, which may be used in fraud detection and prevention through further harm and fraud reduction activities and actions. As such, the risk and fraud detection system and risk analysis models may be used for detection and mitigation of risk, fraud, cybersecurity provision risks across channels, inconsistency in UXs for omnichannel services, data breaches, fraudulent lending across channels, etc., resulting in improved customer personalization and increased trust and loyalty among customers/users.

Such customers may require a digital account with a service provider to utilize the various services provided by the service provider through different communication channels, including multiple channels of one or more omnichannel services. However, some accounts may be fraudulent or may be compromised by an ATO action by a fraudster, leading to fraudulent transactions performed through the account. The risk and fraud detection and mitigation system discussed herein may provide enhancements to existing risk and fraud detection by uncovering complex trend patterns, revealing concentrated behaviors that parties may exhibit, thus offering a more comprehensive view of potential fraud activities or other behaviors of interest. In this manner, improved and more precise training data may be provided for ML model training, which allows for more accurate and reliable automated systems for behavior pattern identification. By identifying and correlating specific activities and/or sequences of activities into behavior patterns, malicious accounts and users may be identified, and their corresponding account data and ML feature data may be used for improved ML modeling and AI system automations. These behavior patterns may be identified without requiring manual identification and configuration, which may take considerable time and effort. As such, AI systems may be trained significantly faster and more efficiently, while providing more accurate models and detection capabilities for a wide range of complex behavior patterns, which results in quicker and more relevant actions that can be taken to mitigate or eliminate fraud and other computing attacks.

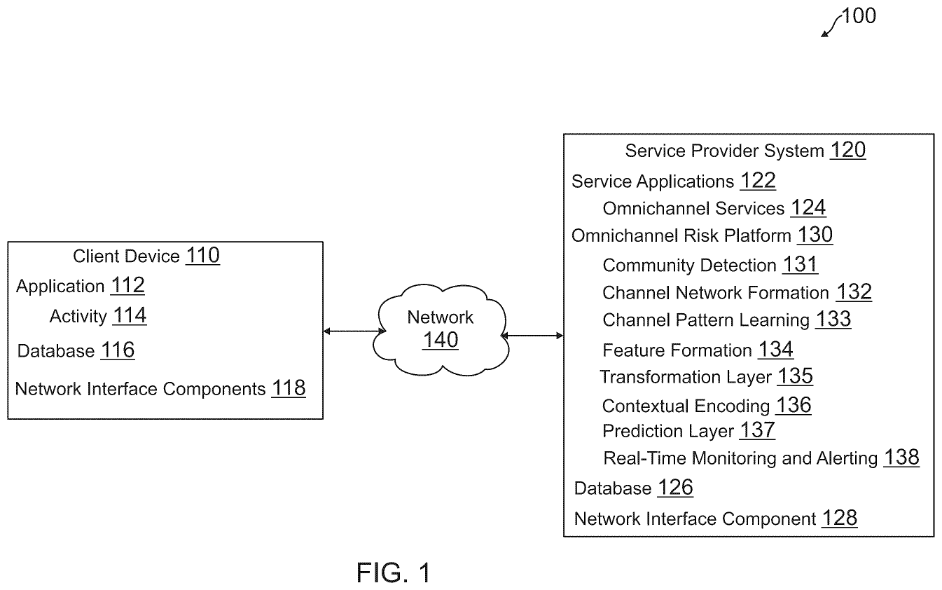

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110 and a service provider system 120 in communication over a network 140. Client device 110 may be utilized by a valid user of an account, or instead may be used by a malicious user or other bad actor to perform fraudulent, malicious, or otherwise unauthorized and/or risky activities using an account over network 140. Service provider system 120 may provide various data, operations, and other functions over network 140 in order to identify if one or more accounts used by client device 110 may be compromised, and therefore engaging in fraudulent activity, or client device 110 may otherwise be engaged in activities and interactions for omnichannel computing services that indicate risk and/or fraud. In this regard, service provider system 120 may automate processes to identify risk and/or fraud in omnichannel computing services using an AI system and models, such as one or more ML models trained for omnichannel risk and fraud prediction and detection.

Client device 110 and service provider system 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device that may utilize appropriate hardware and software configured for wired and/or wireless communication with service provider system 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although a single client device is shown, a plurality of client devices, groups of devices, and/or individual devices with connectable components may be function similarly to client device 110 described herein. As such, client device 110 and/or other similar devices may be used to engage in authorized actions/activities, while in other embodiments, client device 110 and/or other similar devices may be used to engage in fraudulent or unauthorized actions/activities.

Client device 110 of FIG. 1 contains an application 112, a database 116, and a network interface component 118. Application 112 may correspond to executable processes, procedures, and/or applications with associated hardware. In other embodiments, client device 110 may include additional or different modules having specialized hardware and/or software as required.

Application 112 may include different processes executable by software modules and associated components of client device 110 to provide features, services, and other operations to a user, which may include accessing and/or interacting with service provider system 120, for example, utilizing digital accounts to process transactions, payments, or transfers or otherwise engage in an activity 114. In this regard, application 112 may correspond to computing software utilized by one or more users of client device 110 to access a website or UI provided by service provider system 120 or another entity (e.g., merchant, service provider, partner or third-party platform associated with service provider system 120) to perform actions or operations. In some embodiments, this may include digital account usage including requests for electronic transaction processing and/or other requests, interactions, and the like that may be performed through different channels of an omnichannel computing service offered to users through the products and services of a service provider corresponding to service provider system 120.

As such, application 112 may facilitate the performance of activity 114, which may correspond to a computing or digital activity performed through a communication and/or computing service channel that allows users to avail themselves and/or their devices of the products and services of the service provider. The channels may be provided for one or more computing services, which may allow the services and/or sub-services, requests, actions, and outputs of the service to be provided in or through multiple different channels that users may interact with and utilize. As such, the service may be referred to as an omnichannel computing service, and application 112 may enable the user(s) of client device 110 to interact with one or more of these channels. Application 112 may therefore access one or more computing services and/or communication channels over network 140.

In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information (e.g., a website for a merchant), presenting the website information to the user, and/or communicating information to the website including navigating between webpages to login to accounts, process transactions, and/or otherwise utilize computing services. However, in other embodiments, application 112 may include a dedicated software application of service provider system 120 or other entity (e.g., a merchant) resident on client device 110 (e.g., a mobile application on a mobile device), which may be configured to view and utilize data via user interfaces (e.g., applications interfaces displayable by a graphical user interface (GUI) associated with application 112) and request execution of computing operations when utilizing accounts with service provider system 120. Application 112 may provide one or more of user interfaces, for example, via GUIs presented using an output display device of client device 110, to enable the user associated with client device 110 to utilize computing services, platforms, and applications of service provider server with accounts, which may request execution of computing operations through user interface commands and other user inputs.

Application 112 may provide transaction processing, such as through a user interface enabling the user to enter and/or view a transaction for processing. This may be based on a transaction generated by application 112 using a service provider platform or website, merchant marketplace, or by performing peer-to-peer transfers and payments via service provider system 120 in conjunction with another account and/or computing device. Application 112 may access accounts and view and/or utilize account information, user financial information, and/or transaction histories. In some embodiments, different services may be provided by service provider system 120 via application 112 including social networking, messaging, media posting or sharing, microblogging, data browsing and searching, online shopping, and other services available through service provider system 120. Thus, application 112 may also correspond to different service applications and the like that are associated with service provider system 120.

When using application 112 on client device 110, a fraudster or other bad actor may engage in fraud and/or other malicious conduct, such as performing fraud through an ATO using compromised credentials or utilizing an account for illegal, illicit, or unauthorized purposes (e.g., with stolen financial information, to perform spoofed or fraudulent transactions, engage in money laundering, sell fake goods or perform non-delivery after sales of goods, products, or services, etc.). As such, application 112 may be used to conduct fraud with other accounts, sellers or merchants, financial institutions, and the like, or may otherwise engage in risky or unauthorized activities. However, in other embodiments, application 112 may be used on client device 110 to conduct valid or authorized transactions through user accounts, and therefore the activities may not be unauthorized or risky.

As such, when using application 112 with service provider system 120 (either validly or fraudulently), risk analysis for fraud detection and mitigation may be performed for the computing operations and activities requested and/or executed by activity 114. Activity 114 may include computing operations and/or activities executed by client device 110 via user interfaces and corresponding data, operations, and the like. As such, application 112 may be used to execute user commands based on user requests, inputs, and the like that correspond to different account usages and activities. Activity 114 may request data processing with or using the requested account in response to one or more inputs, commands, API calls or requests, navigations, and the like. Activity 114 include behaviors, traits, linked or connected users, and/or other data that may be used for risk analysis and which may be logged and recorded by computing logs, transaction records, behavioral or activity logs and data, and/or other data recorded and/or tracked for activity 114, such as a login field and value provided in the login field, recipient user, amount, time, location, etc. Activity 114 may be received and/or logged by service provider system 120, which may then be analyzed for risk and fraud, as well as used during AI model training of AI models for a risk and fraud detection system.

Client device 110 may further include or have access to database 116, which may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the users/client device 110 to service provider system 120.

Client device 110 includes at least one network interface component 118 adapted to communicate with service provider system 120 and/or another device or server over network 140 for electronic transaction processing and other computing services. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider system 120 may be maintained, for example, by an online service provider, which may provide omnichannel services to users and/or other entities over network 140, as well as risk and fraud detection and mitigation systems for the omnichannel computing systems and infrastructure of service provider system 120. In this regard, service provider system 120 includes one or more processing applications which may be configured to interact with client device 110 to determine whether client device 110 is acting fraudulently or engaging in activities in a risky or fraudulent manner in a computing service, interaction, and/or communication channel of an omnichannel service. This may be done using ML models trained on patterns and activity graphs for risk and fraud detection. In one example, service provider system 120 may be provided by PAYPAL®, Inc. of San Jose, CA, USA. However, in other embodiments, service provider system 120 may be maintained by or include another type of service provider.

Service provider system 120 of FIG. 1 includes service applications 122 and an omnichannel risk platform 130, as well as additional components including a database 126 and a network interface component 128. Service applications 122 and omnichannel risk platform 130 may correspond to executable processes, procedures, and/or applications with associated hardware. In other embodiments, service provider system 120 may include additional or different modules having specialized hardware and/or software as required.

Service applications 122 may correspond to one or more processes to execute modules and associated specialized hardware of service provider system 120 to process a transaction and/or provide other computing services to users, which may include omnichannel services 124 provided in multiple different channels. For example, service applications 122 may include a transaction processing application used to process payments and other services to one or more users, merchants, and/or other entities for transactions. In this regard, the transaction processing application and/or platform may correspond to one or more of omnichannel services 124 provided through multiple different channels for interaction with service applications 122 and other components of service provider system 120. A channel may correspond to a method, process, or platform used to interact with and/or engage in activities with service applications 122 including omnichannel services 124. In this regard, a channel may include software platforms, mobile applications, websites, in-person devices and/or machines (e.g., POS devices, ATMs, etc.), call centers and phone systems for voice and/or video calls, messaging or chat platforms and/or numbers, identifiers, or endpoints that can be contacted, and the like. Omnichannel services 124 may provide a product and/or computing service of service applications 122 through multiple ones of these channels, and, as such, may encounter fraud and other risk activities and interactions in these channels and as a result of activities in or through multiple different channels with each omnichannel service.

The transaction processing application and/or risk analysis engines and platforms of service applications 122 may provide risk analysis, fraud detection, compliance, and other security and/or AI systems through ML models trained as discussed herein by omnichannel risk platform 130. In some embodiments, activities of users, devices, accounts, and/or other identifiers of a particular user or entity may be determined, monitored, and/or extracted from interactions with and/or uses of omnichannel services 124, such as activity 114 performed by client device 110 and/or using a digital account. The digital account may be provided to client device 110 via service applications 122 and/or usable with service applications 122 by client device 110. For example, a payment account provided by or used with the transaction processing omnichannel service of service applications 122 may be used to send and receive payments, including those payments that may be enabled through merchant websites, applications, POS devices, and the like. A payment account may be accessed and/or used through a browser application and/or dedicated payment application executed by client device 110, such a payment and/or digital wallet application.

The transaction processing omnichannel service of service applications 122 may process payments and may provide transaction histories to client device 110 and/or another user's device or account for transaction authorization, approval, or denial of the transaction for placement and/or release of the funds, including transfer of the funds between accounts and access of data. Further, omnichannel services 124 of service applications 122 may provide different computing services, including social networking, microblogging, media sharing, messaging, business and consumer platforms, etc. Omnichannel services 124 and other applications and computing services of service applications 122 may be used by users, merchants, customers, and the like through digital accounts. Such activities and interactions may may be monitored and/or analyzed by omnichannel risk platform 130 for risk analysis and/or fraud detection, as well as AI model training, testing, and other deployment for a risk and fraud detection and mitigation system with omnichannel services 124.

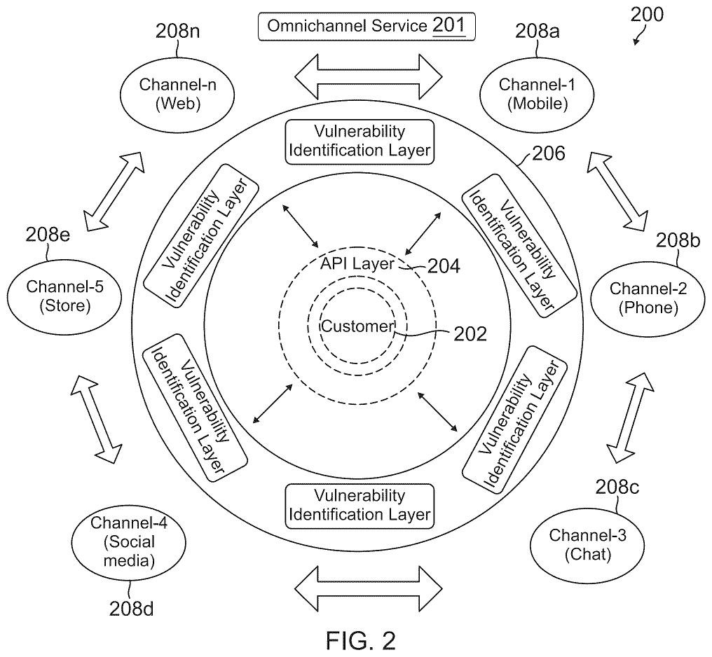

Service applications 122 may employ one or more of the trained ML models to perform risk analysis and determination of risky or fraudulent activity. In response to detecting risk and/or potential fraud, service applications 122 may issue manual challenges, such as CAPTCHA and other requests that may require a user to identify as a human user and/or provide some information so that that user can be verified. This may also include multifactor authentication challenges. In further embodiments, identified risk and/or potential fraud meeting or exceeding a risk threshold, bar, amount, or level may be used to bar, prevent, or reverse further activities engaged in by a computing device using a corresponding account, such as a transaction processed or requested to be processed using the account. Other monitoring and/or alert actions taken based on risk detection may include performing cross-channel analysis and real-time data analysis, security threat monitoring, implementing and/or executing incident management protocols, and/or executing fraud detection alerts, system performance alerts, and/or legal and regulatory alerts. Thus, omnichannel risk platform 130 may interface with, monitor, and/or exchange data with service applications 122 for extracting and processing risk activities for AI system training including training of one or more ML models, as well as risk analysis and fraud detection and mitigations. The operations for monitoring and altering based on omnichannel risk detection and mitigation are discussed in further detail with regard to FIGS. 2-4 below.

Service applications 122 further may provide additional features to service provider system 120 for internal and/or external applications, websites, systems, processors, and the like. For example, service applications 122 may include security applications for implementing server-side security features, programmatic client applications for interfacing with appropriate application programming interfaces (APIs) over network 140, or other types of applications. Service applications 122 may contain software programs, executable by a processor, including one or more GUIs and the like, configured to provide an interface to the user when accessing service provider system 120, where the user or other users may interact with the GUI to view and communicate information more easily. Service applications 122 may include additional connection and/or communication applications, which may be utilized to communicate information to over network 140.

Omnichannel risk platform 130 may correspond to one or more processes to execute modules and associated specialized hardware of service provider system 120 to provide operations, an application, and/or a framework for a risk and fraud detection and mitigation platform, service, and system for service provider system 120, and, in particular, omnichannel services 124. In this regard, omnichannel risk platform 130 may correspond to specialized hardware and/or software used by service provider system 120 to monitor activities for omnichannel risk with omnichannel services 124, including activity 114 from client device 110, which may be performed in one or more channels of omnichannel services 124. Activities may be extracted from monitored computing logs (e.g., network, firewall, or other logs), transaction logs, behavior profiles and/or logs, and/or other activity logs and tracked data. The activities, behaviors, social links or connections, and the like may then be processed for correlation of activity and behavior patterns or sequences, which may be used to risk and fraud detection, as well as alerts and notifications for risk and fraud mitigation. As such, in addition to training and utilizing ML models and other AI systems and components for risk and fraud detection, omnichannel risk platform 130 may perform monitoring and alerting for risk and fraud mitigation

Omnichannel risk platform 130 may include different operations for detection of activities and behaviors using community detection 131. Activities may be extracted and selected for analysis, which may correspond to the data of interest including data variables, features, or log fields that may be used to correlate certain activities across different channels for the same and/or different users, accounts, or the like. Community detection 131 may include use of transaction records, user activity, and/or behavior-based networks, and may include time-series data and/or tabular data. For example, tabular data may include data tables for activities or behaviors that may be time-agnostic or may merely be identified by a time period during which they occurred, where time-series data may include data points recorded over a period of time and/or at intervals usable to identify trends and behavior patterns in activities. Activities may be determined from a network traffic, system event, and/or other computing log generated from interactions by client device 110 with service provider system 120 including machine data and identifiers, IP addresses, payloads, endpoints, API calls and requests, and/or other data relevant to a behavior. A channel network formation 132 may be used to perform co-relation analysis between users and networks of users, where each user (or other identifier of a user, account, entity, device, etc.) may be represented as a node. Channel network formation 132 may the link users to events through edges, and users sharing the same or similar event may also be linked through the edges connecting events. The nodes and edges may be given identification and vulnerable or normal, such that a relationship graph or other representation of the data from community detection 131 may be represented as a graph.

The graphs may correspond to trees or other diagrams of the users, events, activities, and their links to each other. User, event, and/or activity trees or relationship graphs may be generated through combinations of users, events, and activities. Activity trees and/or relationship graphs may then be processed by channel pattern learning 133 that may perform operations for searching and/or identifying patterns that qualify, meet, or may be verified according to the parameters for pattern learning and identification. For example, criteria, such as a baseline pattern, occurrence threshold, or the like, may be used to determine patterns for learning. Thereafter, identified patterns including variant and invariant patterns may be used for modeling of one or more AI models, such as ML models or NNs for fraud detection or other account behavior identification. Variant patterns may indicate behaviors, interactions, and/or characteristics that change across channels and/or between customers and/or users, while invariant patterns have features that may remain consistent across channels.

In order to train ML models using ML features or other AI models and/or systems that may utilize features, variables, and/or other data that requires extraction from the profile data and/or graphs, features may be generated from a feature formation 134. Feature formation 134 may be applied to generate mutable and/or network-structural features, as well as a hybridization of such features, for ML model training. Feature formation 134 may include performing mutable feature extraction and network-structural feature formation and extraction. Feature hybridization may hybridize these features through combining the features of feature formation 134 and providing those features to a transformation layer 135. Transformation layer 135 may use an encoder and decoder to generate the hybridized features using an offset for customer and channel connections in the data. Thereafter, a contextual encoding 136 of the variant and invariant patterns may encode and embed the data from the patterns identified in the graphs using an encoding and/or embedding process, such as a graph-based encoding process.

The output of contextual encoding 136 may be used with the features from transformation layer 135 to train a prediction layer 137, which may include one or more AI models, engines, and/or systems, such as an ML engine having one or more ML models. Prediction layer 137 may provide outputs of risk and/or fraud detection and other analysis, which may be used by a real-time monitoring and alerting 138 to monitor for real-time risk and/or fraud in channels for omnichannel services 124. Omnichannel services 124 may have activities, or users performing those activities, that may span or are performed in multiple channels, that are monitored for their riskiness and potential for fraud. Real-time monitoring and alerting 138 may provide output alerts and other notifications for different systems, users, and/or endpoints. Further, an incident management protocol of real-time monitoring and alerting 138 may implement a process to protect from and/or mitigate damage and loss caused by fraud or other unauthorized activities.

An ML engine for service provider system 120, such as one used by service applications 122 for fraud detection, risk analysis, compliance, and the like with omnichannel services 124, may include one or more AI or ML models, NNs, generative AIs, and the like. For example, with ML models, the models may be trained using the output features from transformation layer 135 and contextual encoding 136. ML models may have trained layers based on training data and selected features or data variables from transformation layer 135 and contextual encoding 136 of omnichannel risk platform 130. For example, ML features or variables may correspond to individual pieces, properties, characteristics, or other inputs for an ML model and may be used to cause an output by that ML model once the ML model has been trained using data for those features from training data. ML models may be used for computation and calculation of model scores, such as fraud detection scores, assessments, or predictions, based on layers, nodes, branches, clusters, rules, and the like that are trained and optimized. As such, ML models may be trained to provide a predictive output, such as a score, likelihood, probability, or decision, associated with a particular prediction, classification, or categorization.

ML models may include DNNs, MLs, LLMs, generative AIs, or other machine-based AI decision engines, systems, and the like, which may be trained using training data having data records that have columns or other data representations and stored data values (e.g., in rows for the data tables having feature columns) for the features. When building ML models, training data may be used to generate one or more classifiers and provide recommendations, predictions, or other outputs based on those classifications and an ML or NN model algorithm and architecture. The algorithm and architecture for the ML models may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input feature data and/or data records, such as by classifying omnichannel activities. Thus, when the ML models are used to perform a predictive analysis and output, the input data may provide a corresponding output based on the trained classifications.

Layers, branches, clusters, or the like of the ML models may be trained by using training data associated with data records of interest, such as omnichannel activities and/or other data associated with users interacting with and/or utilizing omnichannel services 124. By providing training data, the nodes in the hidden layer may be trained (adjusted) such that an optimal output (e.g., a classification) is produced in the output layer based on the training data. By continuously providing different sets of training data and/or penalizing the ML models when the outputs are incorrect, the ML models (and specifically, the representations of the nodes in the hidden layer) may be trained (adjusted) to improve its performance in data classifications and predictions. Adjusting of the ML models may include adjusting the weights associated with each node in the hidden layer. As such, these ML models may be trained and configured based on outputs of transformation layer 135 and contextual encoding 136 generated by omnichannel risk platform 130. The operations for model training for ML models used with omnichannel services 124 and/or ML models for other risk and/or fraud detection and mitigation with omnichannel services and activities are discussed in further detail with regard to FIGS. 2-4 below.

Service provider system 120 includes or may access database 126. Database 126 may store various identifiers associated with client device 110 and/or other devices and/or servers that may engage and/or interact with omnichannel services 124. Database 126 may also store account data, including payment instruments, financial information, account balances, and authentication credentials, as well as transaction processing histories and data for processed transactions. Database 126 may include information for risk and/or fraud detection and mitigation by omnichannel risk platform 130, such as computing logs, transaction histories, logs of interactions and/or activities, and the like. Although database 126 is shown as residing on service provider system 120 as a database, in other embodiments, other types of data storage and components may be used including cloud computing storage nodes, remote data stores and database systems, distributed database systems over network 140 and/or of a computing system associated with service provider system 120, and the like.

In various embodiments, service provider system 120 includes at least one network interface component 128 adapted to communicate with client device 110 and/or other devices, servers, or resources over network 140 for electronic transaction processing and other computing services. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIG. 2 is an exemplary system environment 200 where a machine learning or other artificial intelligence system may be implemented to detect and mitigate fraud and other risk with omnichannel services, according to an embodiment. System environment 200 includes components referenced with regard to system 100 of FIG. 1, such as omnichannel risk platform 130 of service provider system 120. In this regard, system environment 200 includes an exemplary representation of an omnichannel service 201 that may be provided through multiple different channels to a customer 202, where a risk and fraud detection and mitigation system may assist with identifying and mitigating cross-channel threats. Omnichannel service 201 may correspond to one of omnichannel services 124 provided by service applications 122, and may therefore be monitored for risk and fraud caused by cross-channel activities and events performed by users using the risk and fraud detection and mitigation system discussed herein.

In system environment 200, customer 202 interacts with omnichannel service 201 through an API layer 204, which may provide the interface between a client device or other network connected device or component used by customer 202 and omnichannel service 201. In order to provide risk and fraud detection, as well as mitigation from loss or other harm caused by fraud and other unauthorized conduct, a vulnerability identification layer (VIL) 206 may be provided to assist with determination of whether customer 202 is acting fraudulently or in a malicious or unauthorized manner that may cause loss and/or harm to omnichannel service 201, other customers, and/or the service provider. VIL 206 may be provided as a layer between API layer 204 and channels 208a-n, which may each correspond to a communication or interaction channel in which users may connect with and utilize omnichannel service 201. In this regard, VIL 206 may act as a safeguard to monitor, assess, and/or take action against the actions that may be received from API layer 204 for interactions and/or events in channels 208a-n by customer 202.

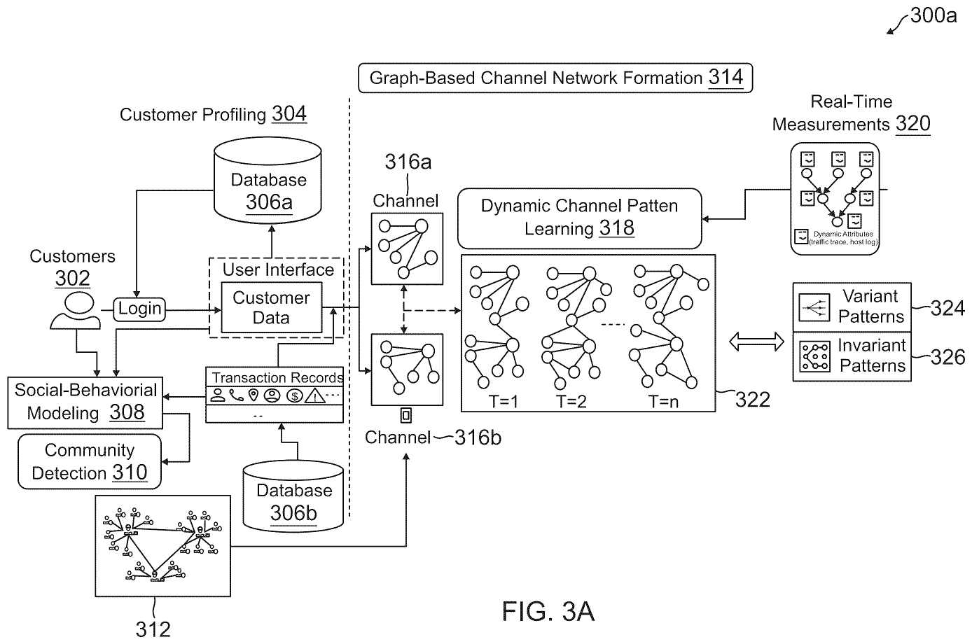

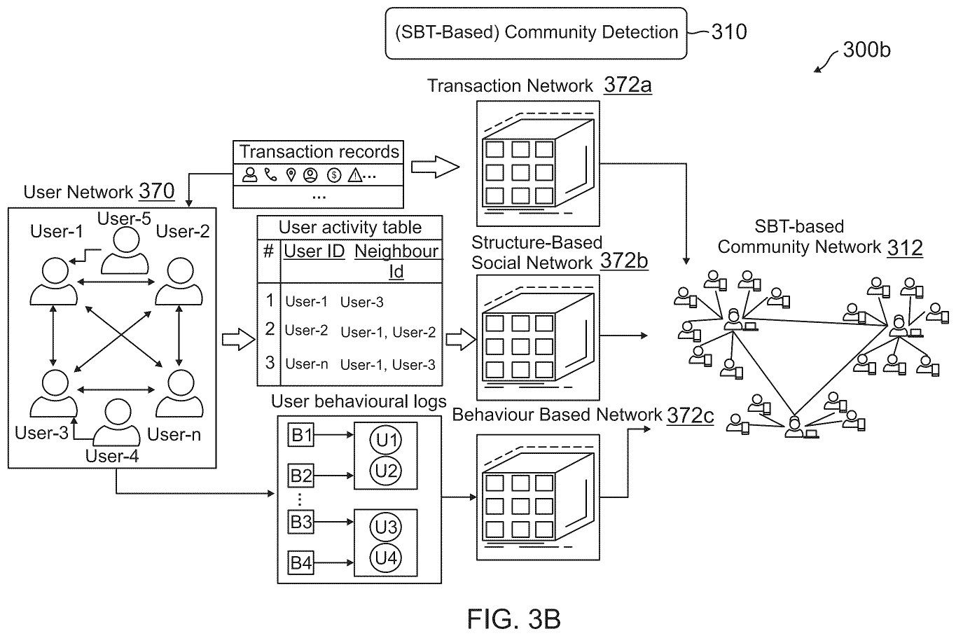

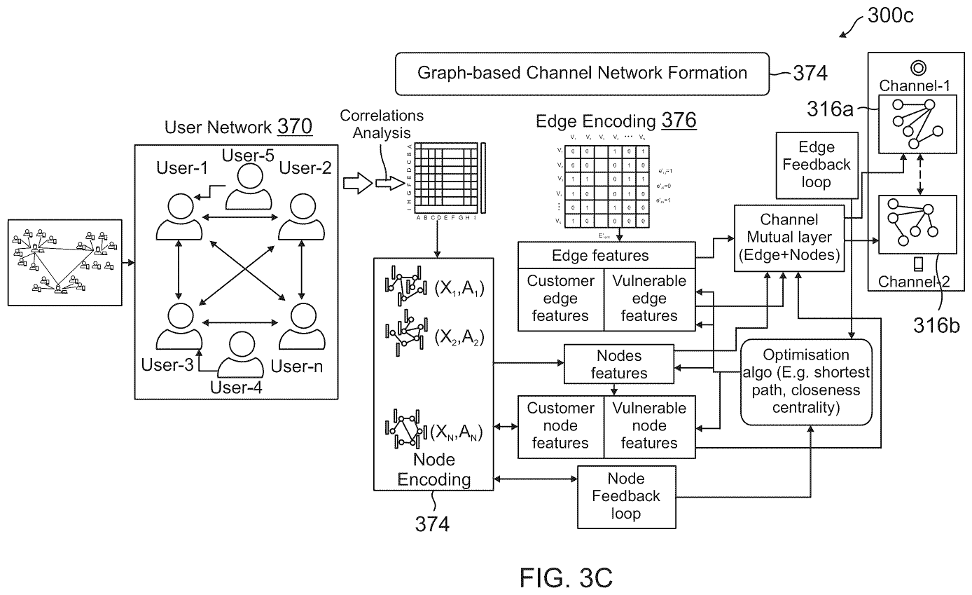

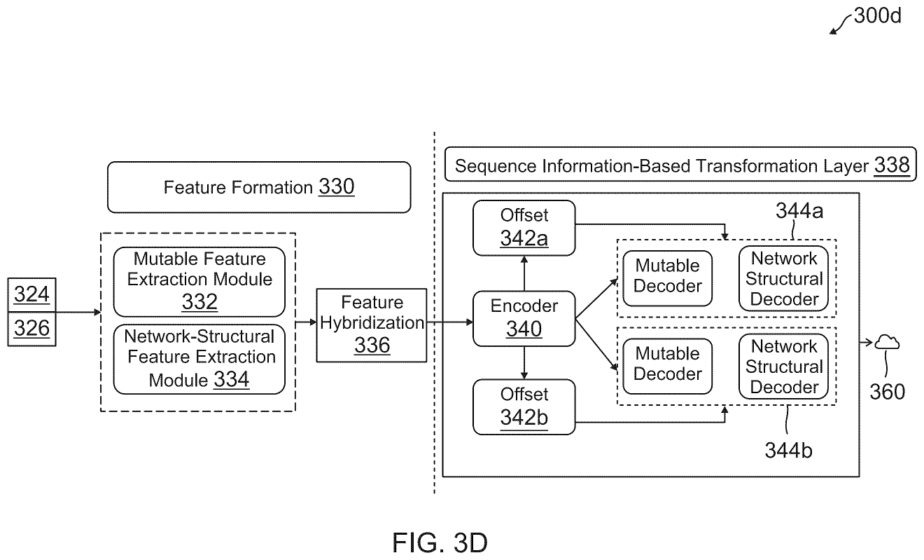

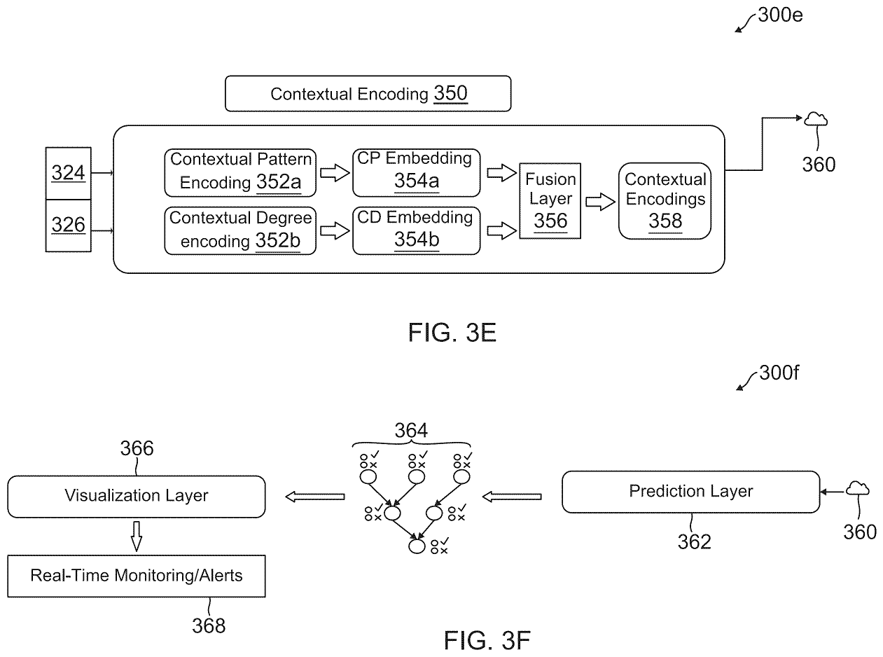

Channels 208a-n may correspond to different processes, methods, and/or communication or interaction pathways in or by which customer 202 may avail themselves of omnichannel service 201, for example, to use the product(s), computing services, platforms, and the like that may be provided by omnichannel service 201. For example, channel 208a may correspond to a mobile channel, channel 208b a phone channel (e.g., PSTN, VoIP, VoLTE, etc.), channel 208c a chat channel or other messaging channel (which may include email, or may correspond to synchronous communications while email may be limited to an asynchronous communication channel), channel 208d a social media channel, channel 208e a storefront or retail location channel (which may include POS devices, payment terminals, ATMs, etc.), and channel-n a web channel (e.g., a website or online resource accessible via a browser). Other types of channels may also facilitate and/or provide omnichannel service 201. Where customer 202 is a legitimate customer, interactions and events of customer 202 received in channels 208a-n by omnichannel service 201 from API layer 204 may be analyzed as determined to be valid by VIL 206, as discussed further with regard to FIGS. 3A-3F below. However, VIL 206 may also provide a protection and risk mitigation layer by detecting harmful, fraudulent, and/or otherwise unauthorized activities and events that may be cross-channel and/or performed in channels 208a-n by customer 202 when received from API layer 204.

FIGS. 3A-3F are exemplary diagrams 300a-300f of a risk and fraud detection and mitigation system for omnichannel services, according to an embodiment. Diagrams 300a-300f of FIGS. 3A-3F includes processes and components executable by the devices, servers, and other computing systems referenced with regard to system 100 of FIG. 1, such as omnichannel risk platform 130 of service provider system 120. In this regard, diagrams 300a-300f show processes that may be performed to extract features and feature data for ML model training and/or inferences that may be used with cross-channel risk and fraud analysis systems, such as those that may perform risk and fraud detection and mitigation with omnichannel services and cross-channel activities and events.

In diagram 300a, data for customers 302 may be processed for determination of cross-channel risk associated with activities performed or engaged in by the users and corresponding events occurring in the different channels of an omnichannel service, such as omnichannel service 201 in system environment 200. Customers 302 may interact with omnichannel service 201 through API layer 204 such that data for a customer profiling 304 may be tracked, monitored, and processed for cross-channel risk and fraud detection, with additional mitigation processes and techniques applied when a risk metric meets or exceeds a threshold. Customer profiling 304 may be based on data stored by databases 306a and 306b, which may include customer data stored by database 306a and/or transaction data stored by database 306b. For example, customer data stored by database 306a may be based on user activities and/or actions including interactions, inputs, activities, and/or other events from a login, to or with one or more user interfaces, and/or other information collected and/or obtained from interactions with API layer 204 by the user using a device, website, application, or the like.

With customer profiling, social-behavioral modeling 308 may be performed for the activities and behaviors of the user. Social-behavioral modeling 308 may correspond to generation of a behavior-based network from monitoring user behaviors. In some embodiments with shopping and/or payment omnichannel services, the behaviors may be associated with a time spent in a channel and/or utilizing the omnichannel service in a channel, search queries and/or item/product searches, digital shopping cart generations and/or abandonments, channel switching rate, and the like. As such, social-behavioral modeling 308 may be based on behavioral logs that are maintained. Community detection may combine the customer's activity, transaction, and/or behavior-based data, such as transaction records having a frequency of purchases, total spending over a period, purchase recency, etc., a user activity table of the user's activity with other neighbor users, and/or social-behavioral modeling 308 and corresponding networks. These networks may be combined into a community network 312, or other network of communities for a user network, that links the user to other users based on connecting events and/or interactions. Diagram 300b in FIG. 3B shows a process for creating community network 312 from a user network 370 based on a transaction network 372a, structure-based social network 372b, and a behavior-based network 372c.

Community network 312 may be provided as input to a graph-based channel network formation 314, which may correspond to an AI process for creation of graph-based channel networks for the user and one or more other users, as well as corresponding relationship graphs that link the user to the other users based on shared or overlapping activities and their events. With graph-based channel network formation 314, a co-relation analysis may be performed for the network of users and events, where edges link users that may be connected based on an event. For the co-relation analysis, a first channel network 316a and a second channel network 316b for different users may be analyzed for node similarities and dependencies of different nodes for users and/or events, where the nodes are similar and/or dependent based on sharing or linking to the same or similar event in one or more channels. The co-relation analysis may be used to combine first channel network 316a with second channel network 316b for a dynamic channel pattern learning 318. The combining of first channel network 316a and second channel network 316b may be performed using node features from the similarities and dependencies of nodes, such as customer node features including demographics (e.g., age, gender etc.), purchase frequency, social connection (e.g., a follower-follow relationship), psychographic features (e.g., product affinity, gifting behavior, etc.), and the like. Vulnerable node features may also be used including structural vulnerabilities (e.g., low-degree centrality of nodes to other nodes, high degree between centrality of the nodes), inconsistent activity pattern, and the like.

Edges between nodes in first channel network 316a and second channel network 316b, as well as the resulting combination for dynamic channel pattern learning 318, may correspond to feature vectors or embeddings, which represent or capture relationships between connected nodes and may have an edge weight, type, or temporal information. For example, customer edge features may include relationships for customer-to-customer, customer-to-product, customer-to-business, or other relationship between users, entities, products, and/or events. For vulnerable edges representing risky activities or interactions, the edges may be based on and/or identified as vulnerable based on a centrality analysis, redundancy check, edge weight analysis, etc. Optimization algorithms (e.g., shortest path, closeness centrality, etc.) may be applied to leverage a node feedback loop and edge feedback loop for better performance and association between users when forming and/or combining first channel network 316a and second channel network 316b. Further, a channel mutual layer may combine the outcome of node and edge features with respect to both customer and vulnerable nodes and edges. Diagram 300c in FIG. 3C shows a process of graph-based channel network formation 314 to obtain first channel network 316a and second channel network 316b using a node encoding 374 and an edge encoding 376.

With dynamic channel pattern learning 318, real-time measurements 320 may be applied when combining first channel network 316a and second channel network 316b for determination of relationship graphs 322. For example, by determining overlapping nodes and/or edges connecting the same or similar nodes, two or more users represented in first channel network 316a and second channel network 316b may be linked into relationship graphs that map and graph the relationships between users and their interactions or other events cross-channel for the different channels of an omnichannel service. Dynamic channel pattern learning 318 may learn from the patterns in channels from relationship graphs 322 that vary over time. This may include analyzing the dynamic activities of normal and/or vulnerable users and/or events in terms of node and edge movement with respect to different timestamps, which include monitoring recurring or emerging patterns in the channels (e.g., spikes in activity, changes in frequency usage across channel, or other measurements from monitoring dynamic attributes, such as traffic trace, host log, etc.). As such, variant patterns 324 and invariant patterns 326 may be determined from dynamic channel pattern learning 318. Variant patterns 324 may indicate behaviors, interaction, or characteristics patterns that change across channel between customer/users. Invariant patterns 326 therefore, unlike variant patterns 324, indicate features that remain consistent across channels.

In diagram 300d, a feature formation 330 is then performed to determine ML features and/or feature data for ML model training and/or inferencing. For feature formation 330, variant patterns 324 and invariant patterns 326 are provided as input to feature extraction modules including a mutable feature extraction module 332 and a network-structural feature extraction module 334. In this regard, variant patterns 324 and invariant patterns 326 may be leveraged from dynamic channel pattern learning 318 to provide outcome features that may be combined by a feature hybridization 336 so that the extracted features may be taken together for processing. This combined feature set may correspond to mutable-network-structure features formed from the feature outputs of mutable feature extraction module 332 and network-structural feature extraction module 334.

For mutable feature extraction module 332 and network-structural feature extraction module 334, the modules may perform feature extraction to output ML model features for feature training and/or inferencing. In this regard, mutable feature extraction by mutable feature extraction module 332 may perform one or more feature extraction techniques to identify dynamic changing feature attributes for transaction data, behavior data, neighbor changes of nodes, frequent node transfer from one channel to other, and the like. Network-structure features extracted by network-structural feature extraction module 334 may correspond to the features that are associated with the formation of the network and may demonstrate how channels are linked and interact with one another. High connectivity enables smooth information flow and seamless transitions between channels, for example when a user starts a product inquiry on social media and completes the purchase on the website. Feature hybridization 336 may then combine these features for a sequence information-based transformation layer 338.

For ML feature and feature data extraction and determination, sequence information-based transformation layer 338 may utilize an encoder and decoder pair for extraction of meaningful features from the network channels based on the output of feature hybridization 336. For example, an encoder 340 may be perform an initial feature encoding by encoding the hybridized features, or the mutable-network-structure features. Channel offsets 342a and 342b may be used to offset or mute different data or features based on the connection of encoder 340. Thereafter, encoded features from customer offset 342a may be provided to a decoder 344a, while encoded features from channel offset 342b may be provided to decoder 344b for decoding. Decoders 344a and 344b include a mutable decoder and a network structural decoder, where the mutable decoder may adapt or change behavior during the decoding process to understand context-awareness, error tolerance, and/or correction from the encoded features, and the network structural decoder may interpret or reconstruct information about a network's structure, which may be applicable for graph reconstruction, link prediction, or generative modeling of networks. A set of ML features may be output and stored by a cloud storage 360 for further use and/or access and processing by other components in diagrams 300a-d.

In diagram 300e, additional ML features may be extracted and encoded for ML model training and/or inferencing. In this regard, variant patterns 324 and invariant patterns 326 may be taken as input for a contextual encoding 350, which may include both pattern encoding and degree encoding. For example, with contextual encoding 350, dynamic channel pattern learning 318 with variant patterns 324 and invariant patterns 326 may be processed by contextual pattern encoding 352a to encode features of identified patterns from variant patterns 324 and invariant patterns 326 that may be observed in relationship graphs 322, which may result in contextual pattern (CP) embedding 354a. Contextual degree (CD) encoding 352 may utilize dynamic channel pattern learning 318 to encode features when considering the calculation of the degree of nodes in the channel network, resulting in CD embedding 354b. A fusion layer 356 may fuse the resulting two embeddings, CP embedding 354a and CD embedding 354b, and contextual encodings 358 may be output by the process of contextual encoding 350, which may similarly be stored by cloud storage 360 for retrieval and/or usage by the components in diagrams 300a-d.

Diagram 300f represents ML model training and/or inferencing using the ML features extracted, encoded, and determined as discussed with regard to diagrams 300a-c. For example, one or more ML models in a prediction layer 362 may be trained using corresponding ML algorithms and/or training techniques, which may be used for ML inferencing of cross-channel risk and/or fraud for omnichannel services. The ML features may be accessed and/or retrieved from cloud storage 360 during ML model training of ML models 364, which may predict whether cross-channel activities and/or users engaging in activities or otherwise associated with events are malicious, benign, normal, vulnerable, or other category. With trained models, the ML feature data from cloud storage 360 and/or provided through a cloud or other networked computing system for inferencing by prediction layer 362 may be processed by prediction layer 362 using ML models 364 for ML model inferencing and risk/fraud assessment, detection, and/or mitigation.

One or more of ML models 364 may provide an output to a visualization layer 366, which may visualize and/or provide usable ML inferencing results. Visualization layer 366 may compare scores or other ML model outputs to one or more thresholds for identification of risk and risk assessment, categorization, and/or assignment (e.g., a risk level, threat classification or categorization, and the like). Visualization layer 366 may also provide ML model explanations using one or more ML model explainer algorithms and/or techniques, which may provide a reason for the ML models output or inference including feature importance and the like. Real-time monitoring/alerts 368 may then generate or provide one or more notifications, alerts, or other outputs utilized to mitigate risk, such as by alerting a user or administrator of risk and/or fraud, preventing an account activity or requiring increased authentication and/or authorization, restricting activities or events from users and/or for performance in a channel of an omnichannel service, or taking other action to minimize and mitigate risk of cross-channel activities from causing loss or damage.

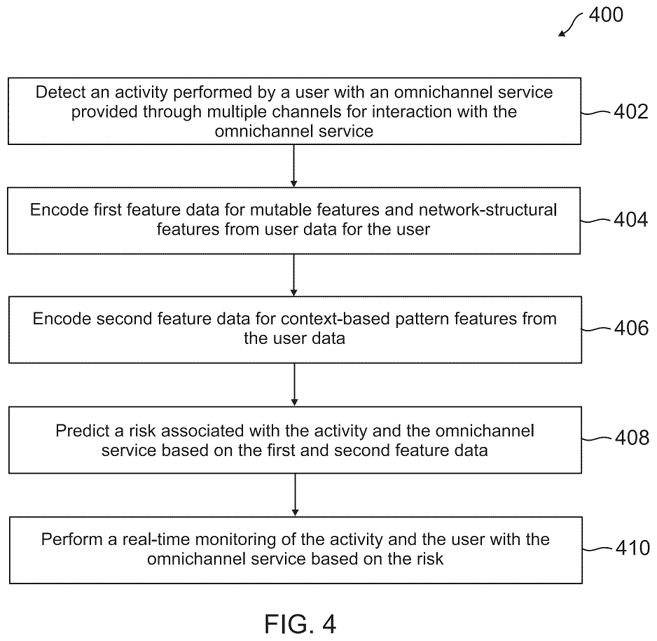

FIG. 4 is a flowchart 400 for risk detection of cross-channel activities for omnichannel computing services with reference to FIG. 1, according to an embodiment. Note that one or more steps, processes, and methods described herein of flowchart 400 may be omitted, performed in a different sequence, or combined as desired or appropriate.

At step 402 of flowchart 400, an activity performed by a user with an omnichannel service is detected, where the omnichannel service is provided through multiple channels for interaction with the omnichannel service. Service provider system 120 may detect, collect, and/or retrieve, from storage or third-party services, activities for different users, devices, accounts, or other identifiers used to track those activities and correlate the activities with a source, originator, or performer of the activities. The activities may correspond to cross-channel activities that may be performed in different channels of an omnichannel service that is provided through multiple different channels. Activities that may be performed with omnichannel services 124 may be based on uses of service applications 122 by the accounts, users, devices, or other identifiers including activity 114 performed by client device 110. Cross-channel activities may be determined from account logs, history, monitored behavior or activities, and/or other data about computing operations engaged in by computing devices using the accounts.

The datasets for processing that may be determined by community detection 131 and include transaction data, behavioral logs and/or monitored behaviors from a user activity table and/or behavior-based network, and other events that occur during transaction processing. Activities and other events may include transactions, login, changing account data, interacting with other online entities and/or accounts, and the like. When training ML models, the accounts, users, or other identifiers for which the dataset is accessed may include all or a sampling of normal, standard, unannotated, or non-flagged accounts (e.g., randomly selected or procedural determined from a general population of accounts), as well as all or a sampling of accounts having a specific behavior, flag, or annotation, such as accounts having fraudulent or spoofed transactions, ATO, fraudulent activity, and the like from cross-channel activities. However, during inferencing, the dataset may be specific to a particular account, user, etc., or set of accounts, users, etc. for risk analysis and/or fraud detection.

At step 404, first feature data for mutable features and network-structural features from user data for the user is encoded. Using the data for the account(s), user(s), etc., graph-based channel networks may be formed by channel network formation 132 to identify the correlations and/or connections between accounts, users, or other identifiers, and the events connected to that identifier. This allows for determination of links between the identifiers and cross-channel activities or events from the resulting graphs, such as activity trees or relationship graphs between identifiers and events, as well as identifiers sharing the same or similar event. As such, channel pattern learning 133 may be used to determine variant and invariant patterns, which may then be used for feature determination and extraction, such as by encoding and/or embedding features from the variant/invariant patterns in the graphs. Feature formation 134 may perform such feature extraction by creating a hybridization of mutable features and network-structural features after extraction of such features from the patterns, and transformation layer 135 may transform this hybridization to processable ML features using an encoder and decoder with channel and/or customer offsets.

At step 406, second feature data is encoded for context-based pattern features from the user data. In addition to the mutable-network-structural features generated from the hybridization of mutable and network-structural features with feature transformation, additional features may be determined from a contextual encoding of the variant and invariant patterns. A contextual pattern embedding may be applied to channel pattern learning 133, and a contextual degree embedding may generate an embedding based on the degree of nodes in the channel network. A fusion layer may then combine the outcome of the contextual pattern embedding and the contextual degree embedding, which may provide a pattern-based contextual embedding based on the pattern and degree of the channel's formation from channel network formation 132 and channel pattern learning 133. The output may provide another set of ML features data for ML features that may be used with ML model training or inferencing.

The ML features and feature data from the training data set extracted and/or determined in this manner may be used with AI model training, such as ML modeling or NN training. An ML algorithm and/or modeling technique may be used to train the nodes, layers, branches, clusters, or the like of the corresponding ML model. In this manner, prediction layer 137 may be trained. After model training, the models may generate output scores, predictions, or decisions, which may be associated with risk and/or fraud detection and may be used to prevent and/or minimize abuse, fraud, and/or loss. With model inferencing and to perform risk and fraud detection and mitigation, at step 408, a risk associated with the activity and the omnichannel service is predicted based on the first and second feature data. Feature data for the ML features used to train the model for cross-channel activity analysis and/or prediction of risk may be extracted in the aforementioned manner and may be input to prediction layer 137 once trained. The ML model may provide an output score, decision, prediction, or the like, which may be used to determine and/or infer whether a cross-channel activity/event or an identifier for a user, account, etc., is risky or potentially fraudulent. One or more thresholds may be used when assessing risk and/or potential fraud labels or indications, such as a low-risk threshold, a medium-risk threshold, a high-risk threshold, etc., each having a corresponding scoring or value threshold that is required to be met or exceeded to trigger that categorization.

At step 410, a real-time monitoring of the activity and the user with the omnichannel service is performed based on the risk. Based on the score of the activity or user, account, etc., the service provider may implement monitoring to prevent and/or mitigate fraud and other abuse. For example, with a user performing a risky activity, this may include performing additional security checks and/or risk analysis of the activity and/or user, as well as related activities, events, and/or users that are connected to the risky behavior and/or user. Alerts may also be generated and sent to further teams, users, or endpoints for review and analysis. If the risk exceeds a threshold or real/potential fraud is detected, one or more security operations may be executed and/or an alert may be set to one or more endpoints of the security operation being executed. For example, the security operation may, on detection of a verified risky sequence and behavior pattern, prevent use of the account including electronic transaction processing. The security operation may also issue manual challenges and/or multifactor authentication.

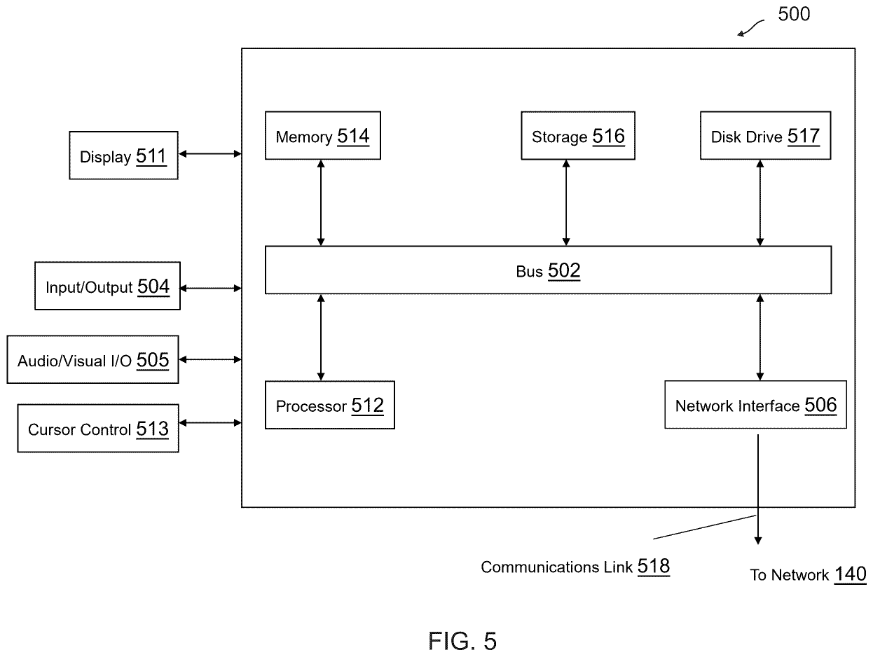

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, images, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output (I/O) component 505 may also be included to allow a user to use voice for inputting information by converting audio signals and/or input or record images/videos by capturing visual data of scenes having objects. Audio/visual I/O component 505 may allow the user to hear audio and view images/video including projections of such images/video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing instructions; and
one or more hardware processors coupled to the non-transitory memory and configured to read the instructions from the non-transitory memory to cause the system to perform operations comprising:
detecting an activity performed by a user using a device in at least one of a plurality of channels of a service provider, wherein the plurality of channels are usable by different users to interact with computing services offered by the service provider;
determining user data associated with the user based on a detection of the user data across the plurality of channels;
encoding, using a first data encoding process associated with mutable features and network-structural features of the user data, first feature data for a first set of machine learning (ML) features associated with first features of an ML model usable for predicting risks associated with activities performed via the plurality of channels;
encoding, using a second data encoding process associated with context-based pattern features of the user data, second feature data for a second set of ML features associated with second features of the ML model;
predicting a risk associated with the activity using the ML model and based on the first feature data and the second feature data; and
performing a real-time monitoring of the activity based on the risk.

2. The system of claim 1, wherein the computing services comprise an omnichannel service provided to the different users via the plurality of channels, and wherein the risks predicted by the ML model are associated with use of the omnichannel service via two or more of the plurality of channels.

3. The system of claim 1, wherein the determining the user data comprises:
determining a transaction history of the user comprising one or more transaction records, a user activity table of the user comprising one or more previous activities with one or more other users, and one or more user behaviors of the user in one or more of the plurality of channels,
and wherein the operations further comprise:
generating a graph-based channel network for the user that links events associated with the transaction history, the user activity table, and the one or more user behaviors.

4. The system of claim 3, wherein the operations further comprise:
forming a relationship graph of the user with the one or more other users based on the graph-based channel network for the user and one or more graph-based channel networks for the one or more other users,
wherein the encoding the first and second feature data uses the relationship graph.

5. The system of claim 4, wherein the operations further comprise:
determining variant patterns and invariant patterns from the relationship graph.

6. The system of claim 5, wherein the encoding the first feature data comprises:
performing a mutable feature extraction associated with the mutable features and a network-structural feature extraction associated with the network-structural features from at least the variant patterns and the invariant patterns;
performing a feature hybridization from the mutable feature extraction and the network-structural feature extraction; and
determining the first feature data for the mutable features and the network-structural features from the feature hybridization using an encoder and a decoder with a channel offset.

7. The system of claim 5, wherein the encoding the second feature data comprises:
performing a first contextual pattern encoding of the variant patterns and the invariant patterns and a second contextual pattern encoding from a channel pattern learning of one or more additional channel patterns between the user and the one or more other users from the relationship graph;
embedding the first and second contextual pattern encodings;
fusing the first and second contextual pattern encoding to a contextual encoding; and
determining the second feature data based on the contextual encoding.

8. The system of claim 1, wherein the operations further comprise:
determining, based on the risk and the real-time monitoring, that the activity or an additional activity of the user has met or exceeded a risk threshold in one of the plurality of channels; and
transmitting an alert associated with the activity or the additional activity to an endpoint designated for the one of the plurality of channels.

9. A method comprising:
detecting an activity performed by a user using a device with an omnichannel service of a service provider, wherein the omnichannel service includes an integrated network for a plurality of channels usable by the device for the omnichannel service;
determining user data associated with the user based on a detection of the user data across the plurality of channels;
determining a graph-based channel network for the user and a plurality of events associated with the user based on previous activities associated with the user in the plurality of channels;
determining a relationship graph of the user to one or more other users based on the graph-based channel network of the user and one or more graph-based channel networks of the one or more other users, wherein the relationship graph links shared events between the user and the one or more other users;
encoding feature data for a plurality of machine learning (ML) features of an ML model using at least two feature encoding processes for mutable features, network-structural features, and context-based pattern features extractable from the relationship graph;
predicting a risk analysis of the activity using the ML model and based on the feature data; and
performing a real-time monitoring of the activity based on the risk analysis.

10. The method of claim 9, wherein the feature data comprises first feature data and second feature data and the encoding the feature data comprises:
encoding the first feature data for a first set of the plurality of ML features associated with the mutable features and the network-structural features using a first encoding process and the relationship graph; and
encoding the second feature data for a second set of the plurality of ML features associated with the context-based pattern features using a second encoding process and the relationship graph.

11. The method of claim 10, wherein the first set of the plurality of ML features comprises one or more encodings based on a combination of the mutable features and the network-structural features.

12. The method of claim 11, wherein the first encoding process is performed using a mutable feature extraction module that extracts the first feature data associated with the mutable features and a network-structure feature extraction module that extracts the first feature data associated with the network-structure features.

13. The method of claim 12, wherein the first encoding process further is performed using a transformation layer that encodes a feature hybridization of outputs from the mutable feature extraction module and the network-structure feature extraction module.

14. The method of claim 10, wherein the second set of the plurality of ML features comprises one or more encodings from pattern-based contextual encodings associated with the context-based pattern features.

15. The method of claim 14, wherein the pattern-based contextual encodings comprise a contextual pattern embedding and a contextual degree embedding.

16. The method of claim 9, wherein the graph-based channel network has a first node of a plurality of nodes corresponding to the user, wherein the plurality of nodes further corresponds to the plurality of events, and wherein a plurality of edges linking the plurality of nodes correspond to one of a normal event link or a vulnerable event link between the user and the plurality of events.

17. The method of claim 16, wherein the determining the relationship graph comprises:
performing a co-relation analysis for the graph-based channel network; and
determining the plurality of edges and one of the normal event link and the vulnerable event link for each of the plurality of edges based on the co-relation analysis.

18. A non-transitory machine-readable medium having stored thereon machine-readable instructions executable to cause a machine to perform operations comprising:
receiving an indication of an event associated with a user that occurred via a cross-channel for a plurality of channels of an omnichannel service;
determining at least one graph-based channel network for the user and the event based on the event and additional data for the event;
encoding first feature data for at least one of mutable features or network-structural features associated with the at least one graph-based channel network;
encoding second feature data for context-based pattern features associated with the at least one graph-based channel network;
determining a risk score for the event based on the first feature data, the second feature data and an output of an ML model trained for cross-channel risk predictions for the plurality of channels of the omnichannel service; and
outputting the risk score to a component for the omnichannel service that issues real-time alerts for the event based on the cross-channel risk predictions.

19. The non-transitory machine-readable medium of claim 18, wherein the encoding the first feature data comprises determining, based on at least one of a variant pattern or an invariant pattern learned from the at least one graph-based channel network, dynamic changing feature attributes associated with the mutable features and network formation features that link the plurality of channels associated with the network-structure features.

20. The non-transitory machine-readable medium of claim 18, wherein the encoding the second feature data comprises performing a contextual pattern embedding and a contextual degree embedding based on the at least one graph-based channel network and at least one of a variant pattern or an invariant pattern learned from the at least one graph-based channel network.
